(19) United States
(12) Patent Application Publication
(10) Pub. No.: US 2022/0053121 A1
(43) Pub. Date: Feb. 17, 2022

(54) A METHOD, SOFTWARE PRODUCT, CAMERA DEVICE AND SYSTEM FOR DETERMINING ARTIFICIAL LIGHTING AND CAMERA SETTINGS

(71) Applicant: PROFOTO AKTIEBOLAG, Sundbyberg (SE)

(72) Inventors: Anton Falk, Huddinge (SE); Tobias Lindbäck, Huddinge (SE)

(21) Appl. No.: 17/274,687

(22) PCT Filed: Sep. 10, 2019
(86) PCT No.: PCT/SE2019/050850

§ 371 Date: Mar. 9, 2021

(30) Foreign Application Priority Data
Sep. 11, 2018 (SE) 1851074-3

(51) Int. Cl. H04N 5/232; H04N 5/225; H04N 9/73

(52) U.S. Cl. CPC H04N 5/23216; H04N 5/2256; H04N 5/2257; H04N 9/735; H04N 5/23222

(57) ABSTRACT

The present disclosure relates to a software implemented method adapted for a camera and artificial lighting system for determining at least one artificial lighting device setting and/or camera setting. The method comprises obtaining first pre-image data relating to at least part of a scene using said camera having a predetermined pre-image camera setting, wherein the first pre-image data is obtained in ambient light, obtaining second pre-image data relating to at least part of the scene using said camera having the predetermined pre-image camera setting, wherein the second pre-image data is obtained from the scene being lightened with the artificial light, receiving user information relating to one or more desired optical characteristics of at least part of an image to be captured using said camera, and determining the artificial lighting setting and/or a camera setting for an image to be captured using said camera based on said obtained first pre-image data, said obtained second pre-image data and said received information relating to the desired or pre-set optical characteristics of at least part of the image to be captured.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

The present disclosure relates to a method for acquiring visual data of a scene and determining the settings for a camera and at least one artificial lighting device.

### Description of the Related Art

Historically the primary use of artificial lighting devices, such as flash devices, in photography has been to capture images under low ambient light conditions. Artificial lighting may also be used to change the optical characteristics of a captured image. In order to capture an image with certain desired optical characteristics, such as the relationship between luminous exposure from ambient and artificial light, certain settings for the camera and lighting device(s) are obtained. Settings such as ISO, aperture and exposure time settings for the camera and intensity, duration and color temperature settings for the lighting device(s). Some DSLR cameras allow the user to input a desired exposure compensation which either underexposes or overexposes the image.

With the high prevalence of camera devices with a lighting device, such as camera phones or tablets, there exists a large population of users with limited understanding of camera and lighting settings.

### SUMMARY OF THE INVENTION

One object of the invention is to facilitate the capture of images for the user.

This has in accordance with the present disclosure been achieved by means of a software implemented method for evaluating a scene pre-image in ambient light and with artificial light in order to determine camera and artificial lighting array settings. The method comprises the step of obtaining first pre-image data of the scene in ambient light conditions via the camera. The method further comprises the step of obtaining second pre-image data of the scene with artificial light via the camera. The method further comprises the step of obtaining user information, such as the desired relation between ambient and artificial light in at least part of the scene. The method further comprises the step of determining the camera and lighting array settings. Scene refers to the field of view of the camera sensor.

Thereby the camera and/or lighting array settings are automatically determined based on user preferences.

This has the advantage that settings do not need to be manually changed during photography. The method also allows users with limited experience of photography settings to successfully operate a camera and lighting array.

The invention also allows for photography with one or more desired user defined optical characteristics, such as relative luminous exposure, exposure value or white balance.

Thus, the above method allows for camera photography with a user defined relationships between the luminous exposure of artificial light and ambient light without manual changes to camera settings or lighting array settings.

Further, the above method allows for camera photography with a user defined exposure value without manual changes to camera settings or lighting array settings.

Further, the above method allows for camera photography with a user defined white balance without manual changes to camera settings or lighting array settings.

Artificial light refers to the light from the lighting array.

Ambient light refers to the light from all sources except the lighting array.

Lighting array refers to one or more artificial lighting devices. A lighting array may comprise an artificial lighting device comprising a multitude of artificial lighting devices.

In one example the method further comprises a step providing at the at least one artificial lighting device the determined artificial lighting device setting and/or providing at the camera the determined camera setting. The providing step may comprise communication with at least one artificial lighting device and the camera. The providing step may comprise a wireless communication interface. This allows for setting to be sent to artificial lighting devices and/or the camera without a physical connection.

In one example the determining comprises determining at least one artificial lighting device setting and/or the camera setting so as to obtain a desired or a pre-set relation between luminous exposure from ambient light and artificial light in at least part of the scene. The relation between the luminous exposures correlates the relationship in brightness between objects in the scene with artificial lighting and objects with significantly less artificial lighting.

In one example the determining step comprises determining at least one artificial lighting device setting and/or the camera setting so as to obtain a desired or pre-set exposure value in at least part of the scene.

In one example the determining step comprises determining at least one artificial lighting device setting and/or the camera setting so as to obtain a desired or pre-set white balance in at least part of the scene.

In one example the camera setting comprises a light sensitivity (ISO) setting and/or an aperture setting and/or an exposure duration (shutter speed) setting.

In one example the lighting array setting comprises a mean light intensity during the exposure setting and/or a mean color temperature setting. In an envisioned method the method provides light sensitivity, aperture and exposure duration settings to the camera, and mean light intensity during the exposure setting and mean color temperature settings to the lighting array. In order for the determining step of the envisioned method to find a unique setting solution at least one desired or pre-set optical characteristic of the image to be captured using said camera is obtained. Here the term “image to be capture” relates to the image detected by the camera sensor.

The present disclosure further relates to a computer program for determining at least one artificial lighting device setting and/or camera setting. The computer program comprises routines for performing the method according to the present disclosure. In one example the computer program is an application on a camera phone and/or tablet. In one example the computer program is integrated into the operating system of a camera phone and/or tablet.

The present disclosure further relates to a computer program product. The computer program product comprises a program code stored on a readable data storage medium for determining at least one artificial lighting device setting and/or camera setting. The data storage medium can be non-volatile. The program code is configured to execute the method according to the present disclosure. The computer program product may provide the camera setting and/or lighting array setting to the camera and/or lighting array. Said computer program product may be an application for a camera phone and/or tablet.

The present disclosure further relates to a camera device comprising a camera connectable to a lighting array, a control element, wherein the control element is arranged to determine settings to the camera and a lighting array according to said method. Said camera device may be a digital camera device. Said camera device may comprise a user interface for receiving the user selection for the desired optical characteristics of an image to be captured using said camera. The user interface may receive the user selection for the part(s) of the scene relating to said desired optical characteristics. Said camera device may be integrated within an electronic user device, such as a camera phone. Said camera device may be a camera phone or a tablet. The camera device may utilize a camera phone software application to carry out the method to determine at least one camera setting and/or lighting array setting.

The present disclosure further relates to a system comprising a camera, a lighting array, a control element, wherein the control element is arranged to determine settings for the camera and the lighting array according to said method. Said system may be a camera phone or tablet. The control element is arranged to communicate with at least one artificial lighting device over a communication interface such as a wireless communication interface. The wireless communication allows the camera and artificial lighting array to function without a physical connection between them.

### BRIEF DESCRIPTION OF THE DRAWINGS

FIG. 1 shows schematically a flowchart of a method according to the present disclosure.

FIG. 2 depicts schematically a scene with part of the scene selected.

FIG. 3 depicts schematically an embodiment of a camera device according to the present disclosure.

FIG. 4 depicts schematically an embodiment of a camera and lighting array system according to the present disclosure.

### DETAILED DESCRIPTION

Throughout the figures, same reference numerals refer to same parts, concepts, and/or elements. Consequently, what will be said regarding a reference numeral in one figure applies equally well to the same reference numeral in other figures unless not explicitly stated otherwise.

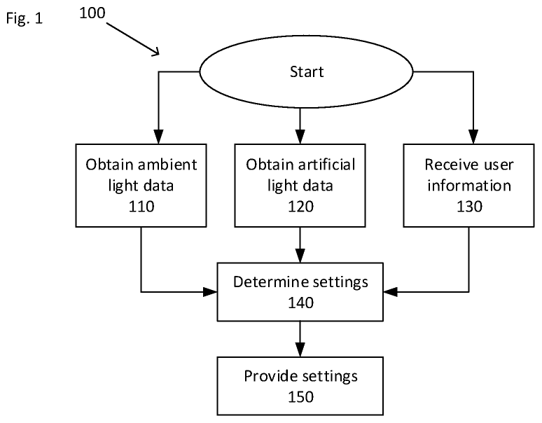

FIG. 1 shows schematically a flowchart of a method 100 according to the present disclosure. It should be noted that not all depicted components are necessary for all embodiments of the method. The method is intended for determining settings for a system comprising a camera and at least one artificial lighting device.

The method comprises a step for obtaining first pre-image data from a scene with ambient light with a camera using predetermined camera setting 110. Here the scene refers to the field of view of the camera sensor. The first pre-image data may comprise image data acquired from the whole of or parts of the scene. Here “the whole of the scene” relates to the full field of view of the camera sensor. The first pre-image data may comprise image data acquired from one or multiple acquisitions. The first pre-image data may comprise an image captured by means of the camera sensor.

The method comprises a step for obtaining second pre-image data from a scene with artificial lighting with said camera using predetermined camera setting 120. The lighting during the obtaining of second pre-image data corresponds to the sum of the ambient lighting and the light from the artificial lighting device(s). The second pre-image data may comprise image data acquired from the whole of or parts of the scene. The second pre-image data may comprise image data acquired from one or multiple acquisitions. The second pre-image data may comprise an image captured by means of the camera sensor.

The artificial lighting used for obtaining the second pre-image data may be produced with predetermined lighting array setting. Lighting array herein refers to one or more artificial lighting devices. The predetermined lighting array setting may be determined based on the first pre-image data from the scene with ambient light. The determination the predetermined lighting array settings may be based on the level of exposure in the first pre-image data. The camera setting may be the same or different from the camera setting used when obtaining the first pre-image data without artificial light 110.

The method comprises a step for receiving user information relating to one or more desired optical characteristics of an image to be captured using said camera 130. The user information may be received by user input of information before or after the timing of obtaining the pre-image data sets. In one example the user information is stored in a memory in the camera device, in a memory in the control element or in a memory in an artificial lighting device. The step of receiving user information then comprises retrieving the user information stored in the camera device, control element or artificial lightning device.

The received user information relating to one or more desired optical characteristics of the image to be captured may relate to the whole of the image or at least one part thereof. The user may select to which part(s) of the image to be captured the one or more desired optical characteristics relates.

The method comprises a step for determining the camera setting and/or artificial lighting array setting 140 utilizing any of the information from the previous steps.

The first and second pre-image data sets may be used to predict the lighting of the scene for the image to be captured. The camera and lighting array settings have characteristically several degrees of freedom. Therefore, in order to determine a single setting at least one user preference and/or pre-set metric is obtained.

In one example, the first and second pre-image data sets are compared to determine how the brightness changes with artificial lighting in at least part of the scene. The camera and/or lighting array settings is determined for an image to be captured using said camera with the user's desired exposure value based on the determined brightness change. In one example the determined brightness change between the first and second image data sets is used to determine the camera and/or artificial lighting array settings to obtain a desired relation between luminous exposure of ambient light and artificial light from at least part of the scene.

In one example the first and second pre-image data sets are compared based on white balance. This means that the camera and artificial lighting array settings for an image to be captured using said camera is determined so that the desired white balance in at least part of the scene is obtained.

The only restriction regarding the order of the steps arises in case one step needs the result of another step as input.

The method may comprise a step providing camera setting and/or setting for at least one artificial lighting device 150. In one example the setting of the lighting array are provided to both the camera and the lighting array, and the camera setting are provided to the camera. In one example the method may be realized as a software application on a camera phone providing the settings to the camera phone's operating system.

The providing of camera setting and/or setting for at least one artificial lighting device may comprise communication with the camera and/or the at least one lighting array. In one example the communication could be via a wireless communication interface. In one example the wireless communication interface could be Bluetooth.

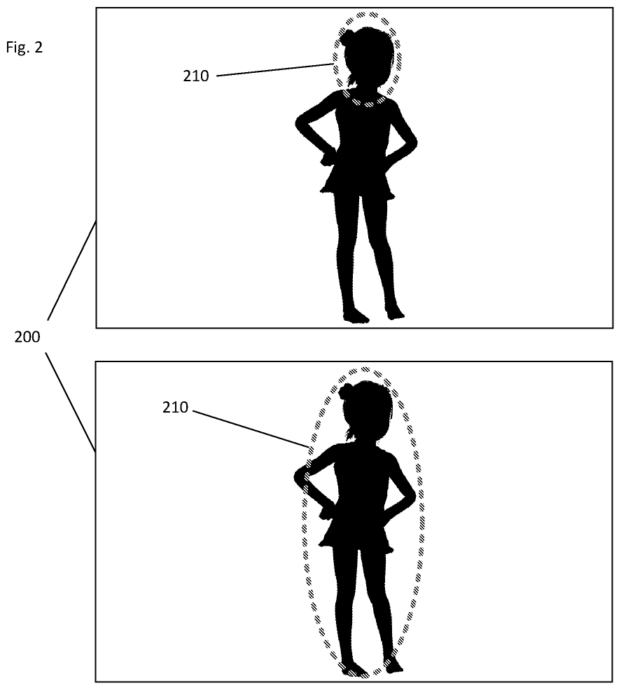

FIG. 2 shows an illustration of a scene 200 with two different parts of the scene 210 selected. In one example the selected part of the scene is defined by the user. In one example the selected part of the scene is defined based on the comparison between the two pre-image data sets. In one example the user may select among a number of suggested part of the scene options defined based on the comparison between the two pre-image data sets. In one example the selected part of the scene is predetermined. The selected part(s) of the scene may be the region of the image to be captured for which the optical characteristics are optimized during the determining settings step.

In one example the camera setting comprise sensor light sensitivity (ISO). In one example the camera setting comprise lens opening (aperture). In one example the camera setting comprise exposure time (shutter speed). In one example the camera setting comprise light sensitivity, lens opening and exposure time, or any combination thereof.

In one example the lighting array setting comprise mean light intensity during the exposure. In one example the lighting array setting comprise mean color temperature. On one example, the lighting array setting comprises mean light intensity during the exposure and mean color temperature.

In an envisioned method the method provides light sensitivity, aperture and exposure duration settings to the camera, and mean light intensity during the exposure and mean color temperature settings to at least one lighting device. In order for the determining step of the envisioned method to find a unique setting solution at least one desired optical characteristic of the image to be captured using said camera is obtained. As an example a user defined exposure value and a desired relation between luminous exposure from artificial and ambient light may result in a unique set of camera and lighting array settings.

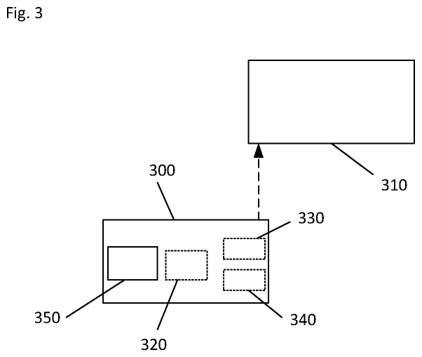

FIG. 3 depicts an example of a camera device 300. The camera device is connectable to a lighting array 310 and a control element with the ability to execute the method previously described. Said camera device comprises a camera sensor 320. Said camera device may be a digital camera device. Said control element may comprise a processor 330 within the camera device 300. Software configured to run on the processor to execute the method previously described may be stored on a data storage unit 340 within the camera device.

The control element may calculate the lighting array settings for the second pre-image data based on the first pre-image data. The control element may calculate at least one selected part of the scene based on the first and second pre-image data sets. The “selected parts of the scene” are the regions taken in account when determining settings, see FIG. 2. The control element may calculate at least one selected part of the scene based on the first and second pre-image data sets for the user to select among. The control element may calculate at least one optical characteristic based on the first and second pre-image data sets. The control element may calculate the camera settings and lighting array settings to best achieve the at least one user desired and/or calculated optical characteristic in at least one user selected and/or calculated part of the scene of the image to be captured.

Said camera device may also comprise an interface 350 for receiving user information relating to one or more desired optical characteristics of an image to be captured using said camera. The interface may provide user selection of at least one optical characteristic. The interface may provide user selection of at least one part of the scene.

The camera device may be integrated into a camera phone or tablet. The camera device could be a camera phone. The camera device could be a tablet.

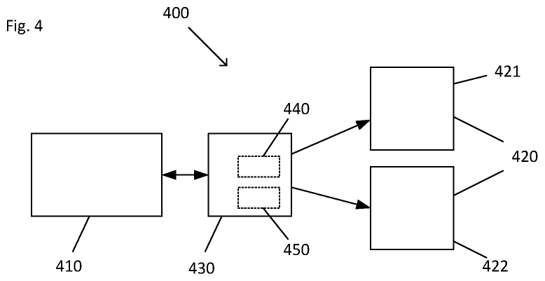

FIG. 4 illustrates a system for controlling a camera device and a lighting array. The system 400 comprises a camera 410, a lighting array 420 and control element 430. The control element may be arranged to execute the method described in relation to FIG. 1.

The lighting array 420 may comprise multiple artificial lighting devices 421, 422. The control element 430 may be a separate device or integrated within the camera device or an artificial lighting device. The control element 430 comprises a processor 440 and a data storage unit 450. The system may comprise a camera with multiple artificial lighting devices and a control element. The control element may be arranged to communicate camera and/or lighting array settings via a wireless communication interface, such as Bluetooth, to the camera and/or lighting array. The system may comprise an artificial lighting devices comprising a plurality of artificial lighting devices. The system could be a camera phone or tablet.

The storage unit 450 is arranged to store a computer program product for performing at least parts of the disclosed method described in relation to FIG. 1. Said computer program product may at least partly be run on said processor 440. Said computer program product may comprise routines for controlling any of said camera 410 and lighting array 420. Said computer program product may comprise routines for accessing the pre-image data from the camera. Said computer program product may comprise routines for accessing the user information regarding the desired optical characteristics in at least part of the image to be captured. Said computer program product can further comprise routines for analysing and processing information received from accessing pre-image data and user information. Said computer program product may comprise routines for determining settings for the camera and lighting array. Said computer program product may comprise routines for wireless communication with the camera and lighting array. In one example the computer program product is a camera phone software program product. In one example, said software may be running on hardware inside the lighting array. In one example, said software may be running on hardware inside the camera device. In one example, said software may be running on hardware inside a device independent of both the camera and the lighting array 430. In one example, said software may be an application on a camera phone or tablet. In one example, said software may be integrated into the operative system of a camera phone. In one example the camera phone software program may be controlling at least one artificial lighting device via Bluetooth.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

1. A software implemented method adapted for a camera and artificial lighting system for determining at least one artificial lighting device setting and/or camera setting, said method comprising
obtaining first pre-image data relating to at least part of a scene using said camera having a predetermined pre-image camera setting, wherein the first pre-image data is obtained in ambient light,
obtaining second pre-image data relating to at least part of the scene using said camera having the predetermined pre-image camera setting, wherein the second pre-image data is obtained from the scene being lightened with the artificial light,
receiving user information relating to one or more desired optical characteristics of at least part of an image to be captured using said camera, and
determining the artificial lighting setting and/or a camera setting for an image to be captured using said camera based on said obtained first pre-image data, said obtained second pre-image data and said received information relating to the desired or pre-set optical characteristics of at least part of the image to be captured.

2. The method according to claim 1, wherein the method comprises providing at the at least one artificial lighting device the determined artificial lighting device setting and/or providing at the camera the determined camera setting.

3. The method according to claim 1, wherein the camera setting comprises a sensor light sensitivity, ISO, setting and/or an aperture setting and/or exposure duration setting.

4. The method according to claim 3, wherein the lighting setting comprises a mean light intensity during the exposure setting and/or mean color temperature setting.

5. The method according to claim 1, wherein the one or more desired or pre-set optical characteristics comprises an exposure value and/or a white balance and/or a relation between luminous exposure from artificial and ambient light.

6. The method according to claim 1, wherein the part of the scene of an image to be captured with desired optical characteristics is selected by the user or predetermined.

7. The method according to claim 1, wherein the determining comprises determining at least one artificial lighting device setting and/or the camera setting so as to obtain a desired or pre-set exposure value in at least part of the scene.

8. The method according to claim 1, wherein the determining comprises determining at least one artificial lighting device setting and/or the camera setting so as to obtain a desired or pre-set relation of luminous exposure for artificial and ambient light in at least part of the scene.

9. The method according to claim 1, wherein the determining comprises determining at least one artificial lighting device setting and/or the camera setting so as to obtain a desired or user set white balance in at least part of the scene.

10. A computer program product for performing the method for determining at least one artificial lighting device setting and/or camera setting according to claim 1.

11. A camera phone software program product for performing the method for determining at least one artificial lighting device setting and/or camera setting according to claim 1.

12. A camera phone software program product for performing the method for determining at least one artificial lighting device setting and/or camera setting according to claim 1, which controls a camera and at least one artificial lighting device, wherein the camera phone software program product is arranged to control at least one artificial lighting device via Bluetooth.

13. A camera device comprising
a camera connectable to an artificial lighting device and
a hardware processor,
wherein the hardware processor is arranged to control the camera and at least one artificial lighting device and wherein the hardware processor is arranged to control the camera to obtain first pre-image data relating to at least part of a scene with ambient light,
control the camera and at least one artificial lighting device to obtain second pre-image data relating to at least part of the scene with the artificial light, and
control at least one artificial lighting device and/or camera setting based on said obtained first pre-image, said obtained second pre-image and information relating to one or more desired or pre-set optical characteristics of an image to be captured using said camera.

14. The camera device according to claim 13, further comprising a user interface for receiving user information relating to one or more desired optical characteristics of at least part of an image to be captured using said camera.

15. The camera device according to claim 13, wherein the camera device is integrated within an electronic user device such as a camera phone.

16. A camera phone comprising a camera device according to claim 13.

17. A system comprising
a camera device according to claim 13 and
at least one artificial lighting device.

18. The system according to claim 17, wherein the camera device is arranged to communicate with the at least one artificial lighting device over a communication interface such as a wireless communication interface.

19. The system according to claim 17, wherein the camera device is arranged to communicate with at least one artificial lighting device over a Bluetooth interface.

20. The system according to claim 18, wherein the camera device is arranged to communicate settings to at least one artificial lighting device over the communication interface.

21. The system according to claim 17, wherein at least one artificial lighting device comprises a plurality of artificial lighting devices.

22. The system according to claim 17, wherein the camera device is integrated within a camera phone.
